(19) United States
(12) Patent Application Publication
(10) Pub. No.: US 2020/0331097 A1
(43) Pub. Date: Oct. 22, 2020

(54) APPARATUS AND METHOD FOR MATERIAL PROCESSING

(71) Applicants: Dirk PETRING, Herzogenrath (DE); Frank SCHNEIDER, Aachen (DE); stoyan STOYANOV, Aachen (DE); FRAUNHOFER GESELLSCHAFT ZUR FOERDERUNG DER ANGEWANDTEN FORSCHUNG E.V., MUNICH (DE)

(72) Inventors: DIRK PETRING, HERZOGENRATH (DE); FRANK SCHNEIDER, AACHEN (DE); STOYAN STOYANOV, AACHEN (DE)

(21) Appl. No.: 16/648,297

(22) PCT Filed: Aug. 30, 2018
(86) PCT No.: PCT/EP2018/000419

§ 371 Date: Mar. 18, 2020

(30) Foreign Application Priority Data
Sep. 4, 2017 (EP) 17 001 479.9

(51) Int. Cl. B23K 26/06; G02B 27/00; G02B 27/30; G02B 27/09; G02B 19/00; B23K 26/073

(52) U.S. Cl. CPC B23K 26/0648; B23K 26/0665; G02B 27/0025; G02B 27/30; B23K 26/36; G02B 19/0014; G02B 19/0047; B23K 26/073; G02B 27/0955

(57) ABSTRACT

Apparatuses and methods for material processing are disclosed. In an embodiment, an apparatus may include a source of electromagnetic radiation that emits the radiation in a beam with a defined power density distribution and beam-shaping optics variably shaping and focusing the radiation of the beam source. An optical axis of the radiation may be directed onto a processing zone. The apparatus may also include means for holding the radiation in a region wherein the radiation interacts with a material forming and moving in the processing zone; as well as an adjusting device that varies the second beam parameter product by changing at least one of a position and an optical property of at least one optical element. In an embodiment, a first optical element of the beam-shaping optics generates or increases the amount of an aberration; and a second optical element of the beam-shaping optics changes an amount of an aberration generated or increased by changing, using the adjusting device, a position or optical properties the first and/or the second optical element, such that the second beam parameter product is adjusted.

### CROSS REFERENCE TO RELATED APPLICATIONS

This application claims priority to International Application No. PCT /EP2018/000419, published as WO2019/042581, the disclosure of which is incorporated herein in its entirety.

### INTRODUCTION

The invention relates to an apparatus and method for material processing.

Such a device for material processing has at least one beam source of electromagnetic radiation, which emits radiation with a defined power density distribution. The radiation from the beam source is guided by beam-shaping optics that variably shape and focus the radiation. The optical axis of the focused radiation, also referred to as the beam axis, is directed onto a processing zone. Furthermore, devices are present that keep the radiation in the area of the interaction surface of radiation and material that is forming and moving in the processing zone. The emitted radiation has a first beam parameter product and the radiation in the processing zone where the radiation interacts with the material has a second beam parameter product.

Variable shaping of the radiation here means that the radiation is shaped with respect to its beam parameter product, especially regarding its radial and axial power density distribution, in order to suitably adjust the radiation effect in the workpiece, for example along or on a cutting front, in a borehole or in a welding capillary.

A corresponding, known method for material processing employs at least one beam source of electromagnetic radiation, in particular a laser beam source, wherein the beam source emits the radiation, which has a first beam parameter product, with a defined power density distribution and the radiation of the beam source is variably shaped and focused by beam-shaping optics. As already mentioned, the optical axis of the focused radiation, referred to as the beam axis, is directed onto a processing zone, and the radiation is kept within the area of the interaction surface of radiation and material forming and moving in the processing zone. The radiation in the processing zone, in which the radiation interacts with the material, has a second beam parameter product.

A beam source of electromagnetic radiation includes in particular laser beam sources, but also MASER (coherent microwave sources) or coherent, extremely short-wave beam sources in the extreme ultraviolet or X-ray wavelength range.

The beam parameter product, referred to as BPP, as mentioned above, refers to the beam quality of the radiation as well as its focusing ability and is defined by the following formula:

BPP=φ·r₀=M²λ/π

where

φ=half opening angle of the radiation in the far field

r₀=radius of the beam at its waist

M²=beam quality factor

λ=wavelength of the beam

The radius of the beam at its waist corresponds to half the focal point diameter. The focusing ability of the beam deteriorates with an increasing beam quality factor M²; the beam quality factor is always greater than or equal to 1.

The apparatuses are used advantageously wherever the radiation of at least one beam source is employed to process materials or substances and where the interaction of the radiation with the material is influenced by the three-dimensional expansion and distribution of the beam power density, also referred to as beam distribution. Processing methods in which these radiation properties are of particular importance are those in which an interaction surface penetrates into the material due to the beam-material interaction. These include, for example, cutting, ablating, drilling, scoring, perforating and deep welding. Depending on the method to be applied and its intended properties, the three-dimensional expansion and distribution of the beam power density and, if necessary, also the distribution of the local direction of the Poynting vectors indicating the density and the direction of energy transport, i.e. the power density, of an electromagnetic field should be adjusted suitably.

In the prior art, different apparatuses and methods for material processing with laser radiation are known in which the properties of the laser beam distribution can be adjusted.

EP 0 723 834 A1 describes a laser system in which a focused laser beam with variable diameter is generated in a defined focal plane. In particular, zoom optics are used to adapt the beam diameter in the interaction region by changing the imaging ratio.

In the prior art, fiber optics are also known to adapt the beam quality (focusing ability) and/or the beam profile by coupling the original laser beam to combined core-ring fibers or by manipulating the beam coupling position and beam direction at the fiber entry of the adapting fiber to change the beam divergence and distribution at the fiber exit.

DE10 2007 024 700 A1 describes a method and an apparatus for material processing using laser radiation, in which the laser radiation is focused such that components of the laser radiation are directed away from the beam waist not only in the direction of propagation after the beam waist, but also in the beam waist and/or also in the direction of propagation before the beam waist, and that these components and the divergence angles are greater than those of the effects of imaging errors that are unintentionally created and accepted using standard optics. Axicons for the generation of annular beam profiles by conical surface portions of the beam-shaping optics and diffraction optics to adapt the beam distribution by influencing the wave front are also specified.

DE 10 2015 101 263 A1 describes an apparatus for material processing by means of laser radiation, in which an adjustment optics for focusing the laser radiation in order to adjust the intensity distribution (power density distribution) has at least two plate-shaped optical elements which are arranged one behind the other in the beam path of the laser beam and which can be rotated against each other in the circumferential direction.

EP 2 334 465 B1 relates to a method for laser beam cutting of a workpiece in which the quality factor (BPP) of the laser beam incident on the workpiece is adapted or modified by means of an optical device. The intention is to obtain a focused laser beam with a modified beam parameter product (BPP), which should be different from the BPP of the incident laser beam. The corresponding apparatus for this comprises at least one transmissive or reflective diffractive optical element, wherein the modified BPP of the focused laser beam differs from the BPP of the incident laser beam by a multiplication factor greater than or equal to 1.2 or less than or equal to 5. The surface of the optical apparatus has microstructures engraved into the substrate of the optical apparatus at various depths in the order of magnitude of the working wavelengths. Consequently, diffraction optics are described to adapt the beam distribution by influencing the wave front.

WO 2016/209800 A1 describes a laser system that focuses the radiation onto a workpiece to be processed and changes the spatial energy distribution on the workpiece. For this purpose, movable optics are used, which comprise a collimating lens, a focusing lens, a system for changing the position of the optical element within the radiation path and a control unit for controlling this system. The moving optics are arranged in front of the collimating optics to influence the spatial power distribution.

US 020150378184 A1 describes a beam parameter adjustment system and focusing system to change the spatial power distribution of a beam from a beam source and to focus the radiation with a changed spatial power distribution onto a workpiece. A thereto-optical element is used to receive the radiation and forward it to the workpiece, wherein the thermo-optical element is heated by a heat source to change refractive indices. The thereto-optical element and the heat source are controlled by a control unit to achieve a required spatial power distribution on the workpiece.

DE 10 2014 207 624 A1 describes an apparatus and a method for material processing. The apparatus comprises a fiber laser system having a laser beam output and further comprises a zoom optical system which is arranged in the beam direction of the laser beam of the fiber laser system between the laser beam output, for example a fiber end, and a material processing area, for example a work surface.

The main disadvantages associated with the prior art can be summarized as follows:

The employed zoom optics influence only the imaging ratio (and thus the F-number defined as the ratio of focal length (f) to diameter (D) of the effective entrance pupil) significantly and thus the spot size on or in the workpiece, but not the beam quality and/or the beam profile. Consequently, such zoom optics allow the focus diameter to be varied by changing the effective focal length or the imaging ratio. According to the imaging law of optics, the focus diameter changes in inverse proportion to the beam divergence. The product remains constant. Both quantities can be changed, but not independently of each other.

Fiber optics (or waveguides) are very sensitive at their inlet and outlet due to the high power densities of the radiation used at the respective end faces and require expensive, high-precision adjustable coupling optics and allow only limited, sometimes even only discrete, variability of beam shaping.

Axicons, i.e. special conically ground lenses or mirrors that transform circular radiation into a ring, as well as so-called Siemens star optics, which are made up of radial facets running in a zig-zag pattern in the circumferential direction and thus also cause an annular redistribution of radiation that is, however, interrupted along the circumference of the ring, are very complex in terms of the manufacturing process, especially with regard to mold production, polishing and coating, and are very sensitive to adjustment.

Variable diffraction optics, as employed in the prior art, allow variable beam-shaping or spatial light modulation only in the low power range, since semiconductor elements available today, with which the phase shift can be changed locally, generate too high thermal losses, which at higher power densities lead to malfunctions or even destruction of the sensitive optics. The document mentioned even limits itself to only “scored”, i.e. fixed non-variable diffractive optics, whose power handling capacity is also very limited and which, like all diffractive optics, also cause system-immanent diffraction losses.

Optics in addition to the standard optics, which consists of collimating and focusing optics, whereby the additional optics are arranged in front of the collimating optics, unnecessarily increase the overall optical system and the number of optical elements. In addition, the boundary conditions specified by the standard configuration unnecessarily restrict the beam-shaping variation range that can be generated with reasonable effort.

Thermo-optical elements, as used according to the prior art, allow only a sluggish and comparatively inaccurate variation of the beam distribution.

Incrementally, discretely moving optics, for example in the form of revolver optics or optics switching to different fibers, which only switch between discrete optical states, are thus significantly limited in terms of their variability.

### BRIEF DESCRIPTION OF THE INVENTION

The problem addressed by the present invention is that of at least partially eliminating the disadvantages listed above with reference to the prior art. In particular, an apparatus is to be specified that forms a process-optimized, three-dimensional absorption surface starting from the surface of the workpiece and extending into or through the workpiece.

The problem is solved by an apparatus with the features of claim 1. According to the method, the problem is solved by a method through the features of claim 16. Preferred developments of the apparatus and the method are specified in the respective dependent claims.

The apparatus according to the invention, having the features described above, is wherein an adjusting device is provided which varies the second beam parameter product by changing the position or the optical properties of at least one optical element. The beam-shaping optics has at least one first optical element and one second optical element. The at least one first optical element generates the amount of an aberration and/or increases the amount of an aberration, while the at least one second optical element of the beam-shaping optics changes the aberration generated or increased in terms of magnitude through the adjustment of the adjusting device by changing the position or the optical properties of at least the first or the second optical element such that the radiation in the processing zone has the second beam parameter product to be adjusted.

The method according to the invention is wherein the second beam parameter product is varied by changing the position or the optical properties of at least one optical element. Furthermore, with the at least one first optical element of the beam-shaping optics, the amount of an aberration is generated or increased and with at least one second optical element of the beam-shaping optics the amount of an aberration generated or increased in terms of magnitude is changed through the adjustment of the adjusting device by changing the position or the optical properties of at least the first or the second optical element such that the radiation in the processing zone has the second beam parameter product to be adjusted.

Such a device as well as a method according to the invention allows to dispense with sensitive fiber and diffraction optics for beam shaping, to continuously change the beam quality and thus also the beam distribution with high variability and also to use cost-effective optics made of high-quality substrates and having good coating characteristics.

Preferably, the apparatus is configured such that the at least one first optical element of the beam-shaping optics generates or increases the amount of a negative aberration and the at least one second optical element of the beam-shaping optics changes the negative aberration generated or increased in terms of the amount such that the radiation in the processing zone has the second beam parameter product to be adjusted. For this purpose, the position or optical properties of at least the first or second optical element are changed by adjusting the adjusting device. These measures achieve that only a few optical elements need to be optimized computationally by using commercially available optics programs under specification of the desired beam properties.

In a further embodiment of the apparatus, the second beam parameter product, which is minimally adjustable using the adjusting device, does not fall below the value of the first beam parameter product. Preferably, the minimally adjustable second beam parameter product should be identical or only slightly larger than the first beam parameter product, so that the high beam quality remains usable to achieve small spot diameters and high power densities. Furthermore, the maximum second beam parameter product adjustable with the adjusting device should be at least twice, preferably 5 to 20 times, the minimum second beam parameter product adjustable with the adjusting device. Due to these differences between the first and second beam parameter product, the typical application spectrum of high-power laser cutting systems, for example, can be covered completely.

For any beam collimation optics that may already be present in a system to continue to be usable, the beam-shaping optics configured for collimated entry radiation are arranged on the output side of a beam collimation optics, viewed in the direction of propagation of the radiation.

The apparatus according to the invention can also be used in particular if the radiation entering the beam-shaping optics with the first beam parameter product is non-collimated radiation. This eliminates the need for collimation optics without significantly increasing the technical expenditure to dimension the optical elements of the beam-shaping optics. The expenditure can be even lower, since in principle a usual parallelization of the radiation can be omitted using the apparatus according to the invention.

For a technically meaningful adjustment of the required or permissible working distance of the beam-shaping optics to a range desired by the user or to avoid additional axes that are too complex in terms of length and dynamics, a waist distance of a beam waist of the focused radiation to a fixed reference plane of the beam-shaping optics is set to a constant value or varied within fixed limits when varying the second beam parameter product. The limits are defined taking into account the desired working distances, waist positions in the processing area or in the workpiece or the permitted system dimensions and are set accordingly.

In a variation of the second beam parameter product at a varying waist distance of the beam waist of the focused radiation to a fixed reference plane of the beam-shaping optics, the waist distance thereby varies within predetermined limits by at least the first and second optical elements being configured such that at least upon a change in the position or optical properties of at least one of the first or second optical elements the waist distance remains within the predetermined limits.

A third optical element, which can be changed in its position or its optical properties, can be associated with the beam-shaping optics in order to variably adjust the waist distance within the given limits or to keep it constant. The third optical element is positioned for a variable adjustment, also for a constant setting, of the waist distance.

The at least one first and/or the at least one second optical element, or even another optical element, of the beam-shaping optics can have spherical surfaces, thereby significantly reducing the manufacturing costs.

If spherical aberrations do not require a sufficient range of variation for the desired optics configuration or require too large a system complexity, for example regarding the magnitude and number of optical components from which the optical elements must be constructed, the at least one first and/or the at least one second optical element, or even another optical element, of the beam-shaping optics can be provided with aspherical surfaces.

The optical properties of the at least one first optical element and/or the at least one second optical element, or even of another optical element, can be varied by changing the refractive index thereof, the refractive index gradient thereof or the shape thereof, i.e. the shape of the surface(s) of the optical elements. It is advantageous in each case to use the variation method that allows for the desired variation of the beam parameter product in the best and most cost-effective manner. Thus, optics with a variable refractive index or with variable refractive index gradients based on semiconductor materials or liquids (so-called liquid lenses) can be used for the low power range below 100 watts, while for high power in the range above 5 kW, mirror optics with a membrane that reflects the radiation and is deformable via piezo drives or via varying pressure of an internal medium (water, air, oil) may be advantageous.

A negative optical focal length in relation to the at least one first optical element or the at least one second optical element, or also in relation to another optical element, results in the radiation being widened and, in interaction with positive optical elements, aberrations can be generated and changed more efficiently due to the then more easily changeable phase shifts of the wave front of the radiation.

By means of a control module of the adjusting device, the second beam parameter product can be adjusted as a function of a required processing result or at least one set or adjusting process parameter corresponding to at least one predetermined characteristic curve or at least one predetermined characteristic curve field being accessed. The simplest characteristic curve indicates at which setting of an optical element which beam parameter product is generated. If further adjustments are required, for example an additional adjustment of a second optical element, a characteristic diagram is already present. It has proven to be advantageous to use two control variables, for example the positions of a first and second optical element (wherein the numbering is not indicative about the order of the optical elements) to adjust the beam parameter product according to the requirements of the processing process, for example the sheet thickness to be cut, or at least one set or adjusting process parameter, for example the beam power, the processing speed or the process temperature. The dependence of the suitable beam parameter product can be based on empirical knowledge, test series or process simulations and stored as trajectories in the above-mentioned characteristic curve field.

The control module of the adjusting device can also change the second beam parameter product depending on the processing time, i.e. time-dependent, and/or depending on the processing position, i.e. location-dependent, corresponding to a predetermined characteristic curve or a predetermined characteristic curve field. In this case, time dependencies (e.g. ramp or modulation functions) and/or location dependencies (e.g. depending on the radius of curvature at the location of the current processing trajectory) of the beam parameter product to be adjusted and, if necessary, also of the F-number are additionally stored in the control module in characteristic curves or characteristic curve fields, for which, in turn, corresponding trajectories for the control variables of the adjusting device are stored.

In a further embodiment, when the position or the optical properties of at least one of the first or second optical elements are changing along a predetermined characteristic curve or in a predetermined characteristic curve field, the waist distance is retained or set in a defined manner within the predetermined limits. Corresponding boundary conditions are taken into account in the computational configuration and optimization of the properties and positions of the optical elements using commercially available optics programs by means of corresponding entries for the so-called “merit function” (evaluation function).

The control module of the adjusting device can also adjust the second beam parameter product as a function of at least one of the following criteria, namely the material to be processed, the processing process to be performed, the geometry to be processed, the required quality, the set or adjusting process parameters, such as processing speed, beam power, process gas type, process gas pressure, waist position, or from at least one sensor signal dependent on properties of the processing zone, corresponding to at least one predetermined characteristic curve or at least one predetermined characteristic curve field before or during processing in an open or closed control loop.

According to the method, the amount of an aberration (negative in a further configuration) is generated or increased using the at least one first optical element and the aberration generated or increased in terms of the amount (negative in a further configuration) is changed using the at least one second optical element by changing the position or the optical properties of at least the first or second optical element such that the radiation in the processing zone has the second beam parameter product to be adjusted.

Preferably, power density distributions of the focused radiation in planes perpendicular to the optical axis, which penetrate or intersect the processing zone when the focused radiation is applied, with free propagation, without a material (workpiece) in the beam path, are each defined by a first radius r1 defined according to the second moment method and each have a second radius r2. Within a circle with the second radius r2, at least 90%, preferably 95%, and even more preferably between 99% and 100%, of the laser beam power is enclosed, the second radius r2 being set at a maximum of 1.5 times the value and preferably between 1.1 times and 1.3 times the value of the first radius r1.

It is also provided that power density distributions of the focused radiation, in planes perpendicular to the optical axis, which penetrate or intersect the processing zone when the focused radiation is applied, with free propagation, without a material (workpiece) in the beam path, are each defined by a maximum power density which is less than 5 times, preferably less than 2 to 3 times, the mean power density in the respective plane perpendicular to the beam axis on that surface enclosed by a circle of a radius r1 defined by the second moment method.

It has been shown that, depending on the minimum available beam parameter product of the beam source, it is advantageous from a certain processing depth onwards to increase the beam parameter product with increasing processing depth in order to achieve a more uniform, higher quality processing result. Processing depth is to be understood here, for example, as a material thickness to be cut, a required welding depth for a metal joint or the nominal depth of a laser borehole. Below the certain processing depth mentioned above, an increase of the beam parameter product beyond the minimum available beam parameter product would be disadvantageous, as for example the possible processing speeds would decrease. Therefore, a control module of an adjusting device successively increases the second beam parameter product depending on a required processing depth corresponding to at least one predetermined characteristic curve or at least one predetermined characteristic curve field from or above a predetermined processing limit depth with increasing, required processing depth. Here, a successive increase can mean that an increase of the second beam parameter product as a function of the processing depth is performed in discrete steps (step function) or also continuously (continuous function).

With a variation of the second beam parameter product, the control module of the adjusting device can also be used to adjust the F-number of the focused radiation based on at least one predetermined characteristic curve or at least one predetermined characteristic curve field. It has proven to be advantageous to use two control variables, for example the positions of a first and second optical element (wherein the numbering provides no indication about the order of the optical elements) to adjust both the beam parameter product as well as the F-function according to the requirements of the processing process, for example the sheet thickness to be cut, or at least one set or adjusting process parameter, for example the beam power, the processing speed or the process temperature. The dependence of the suitable beam parameter product and the suitable F-number on the above-mentioned requirements can take place on the basis of empirical knowledge, test series or process simulations and can be stored in characteristic curve fields—subordinate to the characteristic curve field that describes the dependence of the beam parameter product and the F-number on the control variables of the adjusting device. In addition, the F-number of the focused radiation can be adjusted on the basis of the predetermined characteristic curve or the predetermined characteristic curve field in such a way that with a larger second beam parameter product the F-number remains constant or is increased.

It should be noted that the subject-matter of the invention is not limited only to rotationally symmetric input or output beam distributions with rotationally symmetric optics, but in the same way also to beam distributions of other symmetries or to asymmetric beam distributions as well as optics of other symmetries, such as cylindrical lenses curved spherically or aspherically in one axis only, can be used for application in the apparatus or method according to the invention. The features according to the invention can also preferably be applied to only one sagittal plane of the radiation.

### BRIEF DESCRIPTION OF THE FIGURES

Additional details and features of the invention will become apparent from the following description of exemplary embodiments with reference to the drawings.

FIG. 1 is a schematic representation of an apparatus according to the invention according to a first embodiment;

FIG. 2 is a schematic representation of an apparatus according to the invention according to a second embodiment;

FIG. 3 is a schematic representation of an apparatus according to the invention according to a further, third embodiment;

FIG. 4 is a schematic representation of an apparatus according to the invention according to a fourth embodiment;

FIG. 5 is a graph illustrating the relative change in the steel parameter product (BPP2) and F-number as a function of the position of the first optical element;

FIG. 6 is a graph illustrating the relative change in steel waist radius, beam parameter product (BPP2) and F-number as a function of the position of the first and second optical element, as well as an adjustment trajectory and the growth direction of beam waist radius (r_{F}), beam parameter product (BPP2) and F-number;

FIG. 7 is three graphs A, B and C, referring to power density distributions of the focused radiation as a function of the beam radius coordinate with respect to a first radius r1 and a second radius r2 defined according to the second moment method, wherein graph A shows a beam cross section with grids whose density is assigned to the power density specifications and the corresponding power densities 0 to Iₘₐₓ of the power density scale, graph B represents the power density as a function of the beam radius coordinate with identification of the beam radius r1 and the beam radius r2, and graph C shows the portion of the enclosed energy as a function of the beam radius coordinate and specifically for the beam radius r1 and the beam radius r2; and

FIGS. 8A and 8B are each a real steel measurement of the beam profile at one setting each of the beam-shaping optics for BBPₘᵢₙ and BPPₘₐₓ, wherein the reconstructed beam acoustics along the beam axis are shown on the left side and two beam cross sections are illustrated on the right side at two characteristic measuring positions with grids, the densities of which indicate the power densities and are associated with the corresponding power densities 0 to Iₘₐₓ of the power density scale.

### DETAILED DESCRIPTION

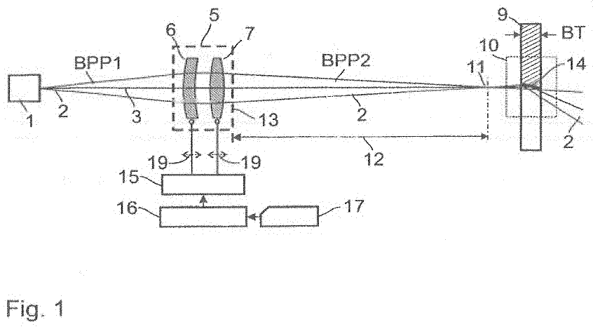

The apparatus according to the invention, as illustrated in FIG. 1 according to a first embodiment, comprises a beam source 1 emitting electromagnetic radiation 2, the beam axis of which is designated by the reference mark 3. Radiation 2 has a defined power density distribution with a first beam parameter product BPP1. The divergent radiation 2 from beam source 1 enters beam-shaping optics 5 as non-collimated radiation.

The beam-shaping optics 5 serves to variably shape and focus the radiation 2 and has at least one first optical element 6 and at least one second optical element 7. In the example shown, the first optical element 6 of this beam-shaping optics 5 is a meniscus lens, while the second optical element 7 of the beam-shaping optics 5, which is positioned behind the first optical element 6 when viewed in the direction of radiation 2, is a biconvex converging lens.

Thus in the first embodiment of FIG. 1, the first optical element 6 and the second optical element 7 of the beam-shaping optics 5 have spherical surfaces. Optical elements 6 or 7 with spherical surfaces have the advantage of significantly lower manufacturing costs, in contrast to optical elements 6 or 7 with aspherical surfaces or whose refractive index or shape can be variably changed and adjusted.

The at least one first optical element 6 generates and/or increases the amount of an aberration, while the at least one second optical element 7 of the beam-shaping optics 5 changes the aberration generated or increased in terms of amount by changing the position of at least the first optical element 6 or the second optical element 7, so that the radiation 2 emitted by the beam-shaping optics 5, which is focused in the direction of a workpiece 9 to be processed, has a second beam parameter product BPP2.

The focused radiation 2 emitted by the beam-shaping optics 5 or the second optical element 7 has a beam waist 11. A waist distance 12 is defined between the beam waist 11 and a fixed reference plane 13 of the beam-shaping optics 5. The reference plane 13 is a plane of the beam-shaping optics perpendicular to the beam axis 3, which is suitable for measuring the waist distance 12, and can be defined arbitrarily but firmly.

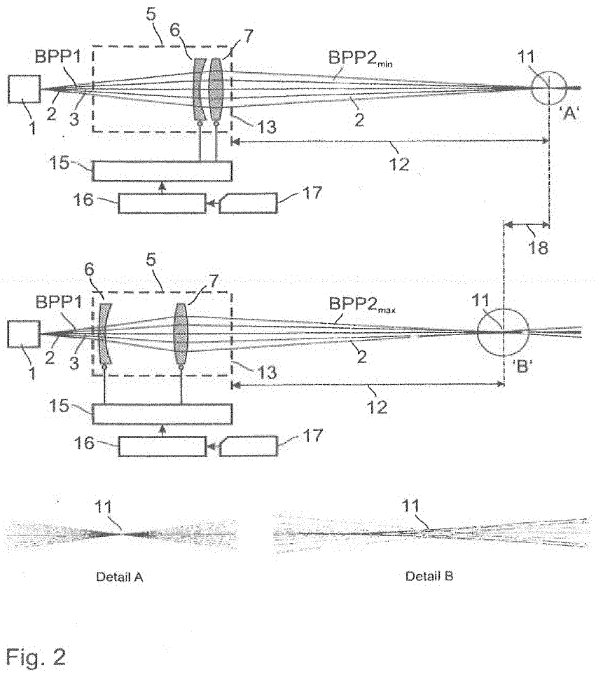

The at least one first optical element 6 of the beam-shaping optics 5 can generate or increase the amount of a negative aberration (shown in detail B in FIG. 2) and the at least one second optical element 7 of the beam-shaping optics 5 can then change the negative aberration generated or increased in terms of amount by adjusting the adjusting device 15 by changing the position of at least the first optical element 6 or the second optical element 7 so that the radiation 2 in a processing zone 10 has the second beam parameter product (BPP2) to be adjusted. The beam parameter product (BPP2) is adapted by generating and increasing in terms of amount a (negative) aberration. For example, the distance between the first optical element 6 and the second optical element 7 is increased to increase the steel parameter product BPP2 and decreased to decrease the beam parameter product PBB2.

A processing zone 10 is defined as the zone in which laser material processing (such as cutting, ablation, drilling, scoring, perforating or deep welding) takes place spatially.

FIG. 1 furthermore specifies a processing depth BT at workpiece 9 as well as an interaction surface 14, i.e. a region where radiation 2 interacts with workpiece 9, wherein in the example shown, the processing depth BT corresponds to the thickness of the workpiece 9 to be processed.

Both the first optical element 6 and the second optical element 7 of the beam-shaping optics 5 can be shifted in the direction of the beam axis 3 via an adjusting device 15, which is controlled via a control module 16, as indicated in each case by a double arrow 19. This shiftability allows the distance between the first optical element 6 and the second optical element 7 and the distance between the first or second optical element 6 or 7 to the beam source 1 to be changed. The type and extent of the adjustment influence the beam parameter product BPP2, the F-number of the focused radiation 2 and its waist distance 12.

In the various embodiments, beam-shaping optics 5 is framed with a broken line and varies in size in the various embodiments shown in FIGS. 1 to 4. The respective size in the direction of the beam axis 3 indicates the range in which the optical elements associated with beam-shaping optics 5, i.e. at least the first optical element 6 and the second optical element 7, can be shifted in the direction of the beam axis 3, as also indicated by the double arrows 19, which, however, are only shown in FIG. 1. Decisive for the determination of the waist distance 12 is the position of the reference plane 13, which, as mentioned above, is arbitrary but constant in that it lies on a plane of the beam-shaping optics perpendicular to the beam axis and is represented in the individual figures as the plane in relation to which the waist distance is specified.

Preferably, the waist distance 12 of the beam waist 11 of the focused radiation 2 to the reference plane 13 of the beam-shaping optics 5 is adjusted such that the waist distance of the beam waist 11 of the focused radiation 2 to the reference plane 13 of the beam-shaping optics 5 is constant with a variation of the second beam parameter product BPP2 or varies within predetermined limits, as explained in more detail below using FIG. 2.

The control module 16 can access a stored characteristic curve or a stored characteristic curve field 17. Data specifying the relationship between characteristic values of the focused radiation (BPP2, F-number, waist radius (r_{F})) and the position or value of an optical property of the elements of the beam-shaping optics can be accessed via such a characteristic curve or such a characteristic curve field 17 and can be used for the adjustment of the second beam parameter product (BPP2) depending on a required processing result or at least one set or emerging process parameter.

By means of the control module 16 of the adjusting device 15, the second beam parameter product BPP2 can also be changed depending on the processing time (time-dependent) and/or depending on the processing position (location-dependent) corresponding to a predetermined characteristic curve or a predetermined characteristic curve field 17.

If a time-dependent change of the second beam parameter product BPP2 is to take place, the position or the optical property of at least one optical element is varied or time-adjusted according to the required processing result or as a function of a set or adjusting process parameter.

A location-dependent change of the second beam parameter product BPP2 is to be carried out if, for example, material processing is carried out on strongly curved paths or if a local adaptation of the process parameters is required, for example, due to locally varying material properties or varying processing depth, while a time-dependent change of the second beam parameter product BPP2 is to be used for cases in which transient processes such as heating of the workpiece or the optics are to be taken into account during processing or are to be compensated by ramping of the beam properties.

By means of the control module 16 of the adjusting device 15, the second beam parameter product BPP2 can be successively increased as a function of a required processing depth BT corresponding to the predetermined characteristic curve or the predetermined characteristic curve field 17 from or above a predetermined processing limit depth BGT as the required processing depth BT increases. The processing limit depth BGT is the predetermined processing depth BT from which a successive change of the beam parameter product BPP2 is made and adapted to the processing depth.

FIG. 2 shows a device according to a second embodiment of the invention. On the basis of FIG. 2, the characteristics and features of the invention regarding the change of the second beam parameter product BPP2 and the waist distance 12 are explained in more detail.

Also in the embodiment of FIG. 2, the beam-shaping optics 5 is composed of a first optical element 6 in the form of a meniscus lens and a second optical element 7 in the form of a biconvex lens. The small distance between the two optical elements 6 and 7 results in low aberration focusing of the emitted radiation 2, so that a beam waist 11 of the focused radiation at a waist distance 12 results, which has a small expansion, as shown in detail A. In this case, a minimum second beam parameter product BPP2ₘᵢₙ is associated with radiation 2 on the output side of beam-shaping optics 5; this is defined as the second beam parameter product BPP2 in which the product of beam waist radius (r_{F}) and beam divergence assumes a minimum value, so that ideally BPP2=BPP1 applies.

By reducing the distance between the first optical element 6 and the beam source 1 and by increasing the distance between the first optical element 6 and the second optical element 7, the contribution of a spherical aberration is generated, as illustrated in FIG. 2. The aberrated beams are focused by the second optical element 7, so that in sum a widened beam waist 11 of the focused radiation below a waist distance 12 results, as shown using detail B. In particular, detail B illustrates a typical radiation pattern with increased negative aberration in terms of amount.

FIG. 2 also makes it clear that by means of the beam-shaping optics 5 and a different positioning of the first optical element 6 and the second optical element 7, the waist distance 12 of the beam waist 11 of the focused radiation 2 to the fixed reference plane 13 associated with the beam-shaping optics 5 varies within predetermined limits 18, i.e. within a range indicated by the double arrow in FIG. 2. By designing the geometry or the optical properties of the optical components accordingly, the region spanned by the specified limits can be reduced or increased.

Furthermore, by designing the geometry or the optical properties of the optical components as well as by suitable positioning along the beam path, it is possible to achieve a variable adjustment of the beam parameter product of the radiation directed onto the processing zone.

FIG. 2 shows the two extreme positions of the optical components of the beam-shaping optics in which the minimum and maximum beam parameter product BPP2ₘᵢₙ and BPP2ₘₐₓ are set. The values of BPPₘᵢₙ and BPPₘₐₓ are dependent on the configuration of the beam-shaping optics according to the invention, which provides that the second beam parameter product BPP2ₘᵢₙ, which can be minimally adjusted using the adjusting device 15, does not fall below the value of the first beam parameter product BPP1 and is preferably identical or only slightly larger than the first beam parameter product BPP1, and in that the second beam parameter product BPP2ₘₐₓ, which can be set to a maximum using the adjusting device 15, is at least twice, preferably 5 to 20 times, the second beam parameter product BPP2ₘᵢₙ, which can be minimally adjusted using the adjusting device 15.

For a technically meaningful adjustment of the required or permissible working distance of the beam-shaping optics from a region desired by the user or to avoid additional axes that are too complex in terms of length and dynamics, the optical components are designed such that the waist distance 12 of the beam waist 11 of the focused radiation 2 to the fixed reference plane 13 of the beam-shaping optics 5 is varied or kept constant within specified limits when varying the second beam parameter product BPP2 by defining the specified limits as boundary conditions in the computational design and optimization of the beam-shaping optics.

In the embodiment of FIG. 2, the first optical element 6 has a negative focal length, which results in the radiation being widened and, in interaction with the positive optical element 7, aberrations can be generated and changed due to the phase shifts of the wave front of the radiation, which are then easier to change.

If the position of either at least the first optical element 6 or at least the second optical element 7 is changed, i.e. if the beam parameter product BPP2 is varied, it can be ensured that the waist distance 12 remains within the predetermined limits 18 by storing the adjustment trajectory for the control variables of the adjusting device 15 in the characteristic curve field 17 such that only regions of the characteristic curve field are adjusted in which the waist distance 12 remains within the predetermined limits 18.

With a variation of the second beam parameter product BPP2, the F-number, i.e. the ratio of the distance of the beam waist 11 to the last optical element of the steel shaping optics 5 at the exit of the beam-shaping optics 5 and the beam diameter at this element of the focused radiation 2, can also be adjusted by the control module 16 of the adjusting device 15 on the basis of a predetermined characteristic curve or a predetermined characteristic curve field 17.

The F-number of the focused radiation 2 can be adjusted on the basis of the predetermined characteristic curve or the predetermined characteristic curve field 17 in such a way that with a larger second beam parameter product the F-number remains constant or is increased. To achieve that the steel divergence remains constant, the F-number is kept at a constant value while it is reduced to increase the beam divergence.

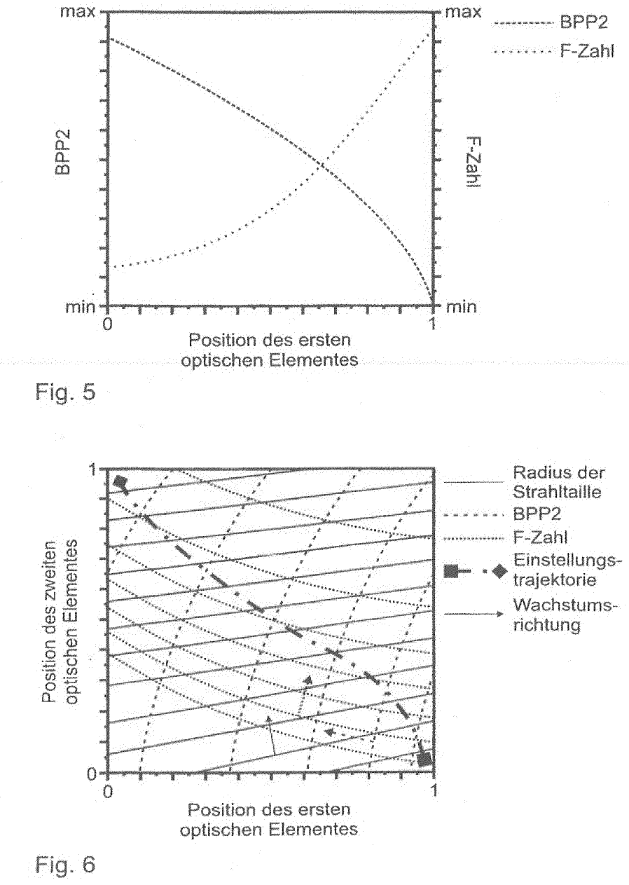

The respective setting parameters and their dependencies on each other are described and demonstrated below using FIGS. 5 and 6.

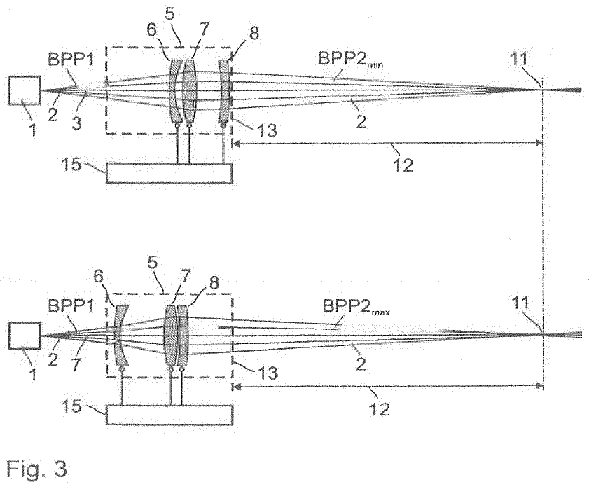

In FIG. 3, which shows a third embodiment of the apparatus according to the invention, the beam-shaping optics 5 has, in addition to the first optical element 6 and the second optical element 7, a third optical element 8 on the output side of the second optical element 7, the position of which can be changed by means of the adjusting device 15. In FIG. 3, the third optical element 8 is a convex-concave lens and is located, for example, close to reference plane 13, while the first and second optical elements 6, 7 are at a small distance from each other, as shown in the upper illustration in FIG. 3. The third optical element 8 of the beam-shaping optics 5 serves to compensate for the change in waist distance 12, which occurs during variation of the beam parameter product BPP2 by shifting the first and second optical elements 6 and 7, and ideally to keep it constant. By arranging the optical elements 6, 7 and 8 within the beam-shaping optics 5, a minimum value of the beam parameter product BPP2 is set, as shown in the upper illustration of FIG. 3.

On the other hand, if, as shown in the lower illustration of FIG. 3, the third optical element 8 is moved immediately behind the second optical element 7 and the first optical element 6 is placed at a greater distance from the second optical element 7 and at the same time closer to the beam source 1, a beam waist 11 with a maximum second beam parameter product BPP2ₘₐₓ is obtained at the same waist distance 12, having an expansion perpendicular to the beam axis 3, as illustrated above using detail B in FIG. 2.

The illustration in FIG. 3 demonstrates that the steel shaping optics 5 not only allows the waist distance 12 to be variably adjusted within predefined limits 18, as explained using FIG. 2, but also to be kept constant.

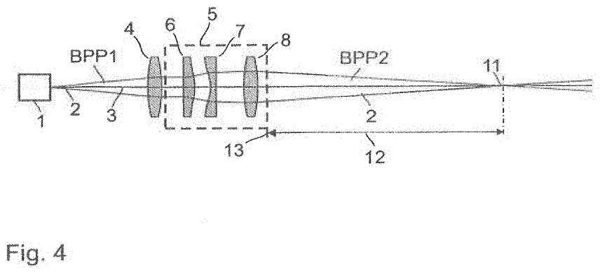

FIG. 4 describes an exemplary embodiment in which a beam collimation optics 4 is arranged in front of the beam-shaping optics 5, so that a collimated beam enters the beam-shaping optics. The beam-shaping optics 5 can be designed according to the examples in FIGS. 1 to 3 or, as shown in FIG. 4, can be equipped with one or more aspherical lenses.

The advantage of using aspherical lenses, as shown schematically in beam-shaping optics 5 of FIG. 4, consists on the one hand in the fact that with optical elements with aspherical surfaces a higher variation range of the beam parameter product BPP2 can be achieved compared to beam-shaping optics with spherical lenses. On the other hand, the beam-shaping optics can be made more compact because, due to the more efficient phase front deformation caused by the aspherical surfaces, the distances at which the optical components must be positioned in relation to each other to generate the limit values of the beam parameter product are smaller.

How the beam parameter product BPP2, the F-number and the radius of the beam waist 11 can be influenced by changing the position of the first and/or the second optical element 6, 7 is described below using FIGS. 5 and 6.

It should be noted that in the description of the various exemplary embodiments, as illustrated in the various figures, not all components are described again for one embodiment if they have already been described or explained using another embodiment. Accordingly, the description of the various components or their mode of operation for one embodiment can be transferred to the respective components of another embodiment without this being explicitly mentioned.

The graph in FIG. 5 is intended to illustrate the dependence of the steel parameter product BPP2 and the F-number on the position of the first optical element 6, using arbitrary units for all axes.

The dependence of the steel parameter product BPP2 on the position of the first optical element 6 is represented by the curve in broken line, while the dependence of the F-number on the position of the first optical element 6 is represented by the curve in dotted line. Position 0 of the first optical element 6 designates the minimum adjustable distance to the previous optical element along the optical axis, while position 1 of the first optical element 6 refers to the maximum adjustable distance to reference plane 13. When the optical element 6 is moved, both the beam parameter product BPP2 and the F-number of the beam change. The characteristic curve can be used to set the desired values of the beam parameter product BPP2 or the F-number, but these are coupled so that they cannot be set independently of each other simply by changing the position of the first optical element 6.

FIG. 6 now shows a graph illustrating a characteristic curve. Depending on the positions of the first optical element (abscissa) and the second optical element (ordinate), lines of constant waist radii (solid), BPP2's (dashed) and F-numbers (dotted) are entered. The growth direction of the isolines is marked by arrows. In contrast to the embodiment as illustrated in FIG. 5, here the positions of two optical elements are varied, which leads to the fact that two of each of the three quantities, for example the beam parameter product BPP2 and the F-number, can be adjusted independently of each other as far as the adjustability of beam-shaping optics 5 allows. For position 0 and position 1, the information and explanations given in FIG. 5 above also apply.

An adjustment trajectory is represented by the dash-dotted line. The adjustment trajectory specifies the control variables for the adjusting device which change the beam parameter product or the F-number depending on the requirements of the processing task (for example, type of processing, processing depth or quality), the process parameters or the processing time, i.e., time-dependent, and/or depending on the processing position, i.e., location-dependent, wherein the starting point near 0.1 is represented by a rhombus and the end point near 1.0 by a square.

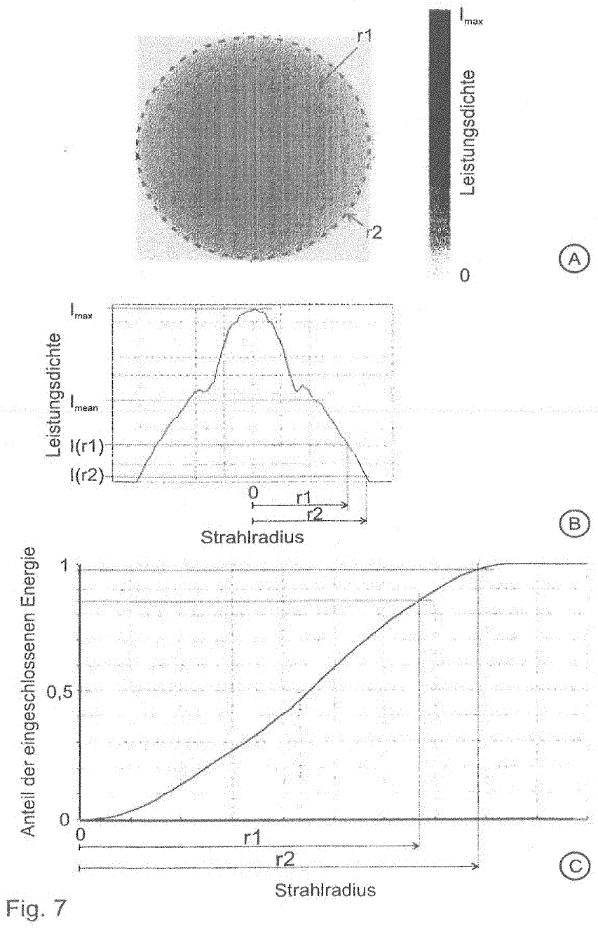

FIG. 7 shows three graphs A, B and C, which refer to the power density distribution of the focused radiation in a plane perpendicular to the optical axis at an arbitrary point in the processing zone, for example at the beam waist, with free propagation, without a material.

Here the radius r1 is the radius defined using the second moment method, while the radius r2 is an auxiliary quantity and is associated with a circle with r>r1, in which almost the entire energy share (at least 90%, preferably between 95% and 100%) is enclosed.

Graph A illustrates a beam cross section of radiation 2 at the position of the beam waist, wherein the grids shown over the beam cross section are associated with the corresponding power densities 0 to Iₘₐₓ of the power density scale. The maximum power density Iₘₐₓ is located in the center of the beam cross section, i.e. in the area of the beam axis 3 in relation to the representation of FIGS. 1 to 4 and at the beam radius coordinate 0, while the power density decreases with increasing beam radius coordinate in the direction r1 and r2 respectively (from a dark, dense grid to a bright, less dense grid).

This is also demonstrated by graph B, which illustrates the power density distribution depending on the beam radius coordinate. The relation of the two radii r1 and r2 to a power density 1(r1) and a power density 1(r2) is illustrated. In addition, graph B demonstrates the position of the maximum power density Iₘₐₓ and the mean power density Iₘₑₐₙ.

The power density distribution of a method according to the invention is characterized, inter alia, by the fact that it is based on planes perpendicular to the optical axis which penetrate or intersect the processing zone 10 when the focused radiation 2 is applied, with free propagation, without a material 9 (workpiece) in the beam path, are each defined by a maximum power density Iₘₐₓ which is less than 5 times, preferably less than 2 to 3 times, the mean power density Iₘₑₐₙ in the respective plane perpendicular to the beam axis on that surface enclosed by a circle of radius r1 defined by the second moment method.

In the graph C of FIG. 7, the portion of enclosed energy corresponding to the portion of enclosed power per time is shown in units from 0 to 1 as a function of the beam radius coordinate and specifically for the beam radius r1 and the beam radius r2 in arbitrary units. The portion of the enclosed energy or power within the radii r1 and r2 is indicated by dotted lines. The power density distribution of a method according to the invention is further wherein, on planes perpendicular to the optical axis, which penetrate or intersect the processing zone 10 when applying the focused radiation 2, with free propagation, without a material 9 (workpiece) in the beam path, each of these planes being defined by a first radius r1 defined according to the second moment method and each having a second radius r2, wherein within a circle having the second radius r2 at least 90%, preferably at least 95%, and even more preferably between 99% and 100%, of the laser beam power is enclosed, wherein the second radius r2 is set to a maximum of 1.5 times the value and preferably between 1.1 times and 1.3 times the value of the first radius r1.

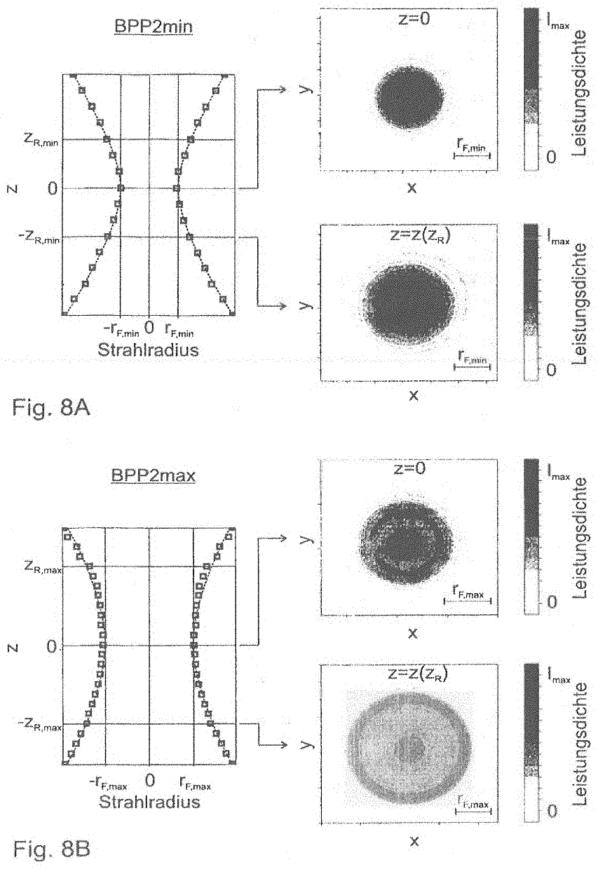

FIGS. 8A and 8B show real steel measurements. The result of a diagnosis of the laser beam profile with beam-shaping optics 5 set for BPPₘᵢₙ and BPPₘₐₓ is presented. During the measurement, the power density distribution of the beam is recorded in several planes along the beam axis 3, defined as the z-axis, in a measurement area around the beam waist 11.

The beam radius r is determined from the power density distribution using the second moment method. By plotting the beam radii along the z-axis the beam caustics can be reconstructed. This is presented on the left side of the figure in the respective graphs of FIGS. 8A and 8B, for an adjustment of beam-shaping optics 5 for BPPₘᵢₙ (FIG. 8A) and for BPPₘₐₓ (FIG. 8B). The radius of the beam waist (r_{F}) is indicated separately on the respective beam radius axis. Two power density distributions at two characteristic measurement positions are presented on the right side of the respective figures; one at beam waist 11 (z=0) and the other at a Rayleigh length (z=z(z_{R})) after beam waist 11. The Rayleigh length (Z_{R}) is defined as the distance from the beam waist in the propagation direction in which the beam radius has increased by a factor of 2½. With the x- and y-axis the lateral expansions of the measuring plane are indicated in x- and y-direction perpendicular to the z-axis (beam axis 3). The presentation scale is defined by the beam waist radius r_{F}. The grid scale indicates the normalized power density measured relative to the beam axis 3 depending on position. Arbitrary units are used for all coordinate axes. In addition, the arrows connecting the caustic with the power density distributions indicate the corresponding positions of the measuring planes on the beam axis z.

What is claimed is:

1. An apparatus for material processing, comprising:
at least one beam source of electromagnetic radiation that emits the radiation with a defined power density distribution;
a beam-shaping optics variably shaping and focusing the radiation of the beam source, wherein an optical axis of the focused radiation, referred to as beam axis, is directed onto a processing zone;
means for holding the radiation in a region of an interaction surface of radiation and material, the interaction surface being formed and moving in the processing zone,
wherein the radiation comprises a first beam parameter product and a second beam parameter product in the processing zone in which the radiation interacts with the material,
an adjusting device that varies the second beam parameter product by changing at least one of a position and an optical property of at least one optical element,
and wherein:
a first optical element of the beam-shaping optics at least one of generates and increases the amount of an aberration; and
at least one second optical element of the beam shaping optics changes an amount of an aberration generated or increased by adjusting the adjusting device by changing the position or the optical properties of at least one the first and the second optical element such that the radiation in the processing zone comprises the second beam parameter product to be adjusted.

2. The apparatus of claim 1, wherein the at least one first optical element of the beam-shaping optics at least one of generates and increases the amount of a negative aberration, and the at least one second optical element of the beam-shaping optics changes the amount of the negative aberration by changing, using the adjusting device, at least one of the position and optical properties of at least one of the first and the second optical element, such that the radiation in the processing zone comprises the second beam parameter product to be adjusted.

3. The apparatus of claim 1, wherein the second beam parameter product is minimally adjustable with the adjusting device, does not fall below the value of the first beam parameter product and, is at least one of identical to and slightly larger than the first beam parameter product, and the second beam parameter product, which is maximally adjustable with the adjusting device, is at least twice, preferably 5 to 20 times, the second beam parameter product, which is minimally adjustable with the adjusting device.

4. The apparatus of claim 1, wherein the beam-shaping optics, viewed in the direction of propagation of the radiation, is arranged on the output side of a beam-collimating optics.

5. The apparatus of claim 1, wherein the radiation entering the beam-shaping optics with the first beam parameter product is a non-collimated radiation.

6. The apparatus of claim 1, wherein a waist distance of a beam waist of the focused radiation to a fixed reference plane of the beam-shaping optics is at least one of constant and varies within predetermined limits upon variation of the second beam parameter product.

7. The apparatus of claim 6, wherein upon variation of the second beam parameter product at a varying waist distance of the beam waist of the focused radiation to a fixed reference plane of the beam-shaping optics, the waist distance varies thereby within predetermined limits, such that at least the first and the second optical element are configured such that at least when the position or the optical properties of at least one of the first and the second optical element change, the waist distance remains within the predetermined limits.

8. The apparatus of claim 6, wherein the beam-shaping optics comprises a third optical element which is changeable in its position or optical properties such that the waist distance is at least one of variably adjustable within predetermined limits and constant.

9. The apparatus of claim 1, wherein the at least one of the first and second optical element of the beam-shaping optics has spherical surfaces.

10. The apparatus of claim 1, wherein the at least one of the first and second optical element of the beam-shaping optics has aspherical surfaces.

11. The apparatus of claim 1, wherein the at least one of the first and second optical element is variable by changing at least one of its refractive index, its refractive index gradient, and its shape.

12. The apparatus of claim 1, wherein the at least one of the first and second optical element has a negative optical focal length.

13. The apparatus of claim 1, wherein by means of a control module of the adjusting device, the second beam parameter product is operable to be adjusted in dependence on at least one of:
a required processing result;
a set; and
an adjusting process parameter corresponding to a predetermined characteristic curve or a predetermined characteristic curve field.

14. The apparatus of claim 13, wherein by means of the control module of the adjusting device, the second beam parameter product can be changed dependent on the processing time (time-dependent) and/or dependent on the processing position (location-dependent) corresponding to a predetermined characteristic curve ora predetermined characteristic curve field.

15. The apparatus of claim 6, wherein when the position or the optical properties of at least one of the first and the second optical element change along at least one of a predetermined characteristic curve and in a predetermined characteristic curve field, the waist distance remaining within the predetermined limits.

16. A method for material processing which employs at least one beam source of electromagnetic radiation, in particular a laser beam source , the method comprising:
emitting, using the beam source, the radiation, the radiation having a first beam parameter product with a defined power density distribution and the radiation of the beam source is variably shaped and focused by beam-shaping optics;
directing the optical axis of the focused radiation, referred to as beam axis, onto a processing zone;
maintaining the radiation in a region of an interaction surface of radiation and material, which interaction surface is formed and moves in the processing zone,
having a second beam parameter product in the processing zone;
varying the second beam parameter product by changing at least one of the position and the optical properties of at least one optical element such that an amount of an aberration is at least one of generated and increased with at least one first optical element of the beam-shaping optics; and
changing the amount of at least one of a generated and increased aberration with a second optical element of the beam-shaping optics by changing, using the adjusting device, the position or the optical properties of at least one the first and the second optical element such that the radiation in the processing zone comprises the second beam parameter product to be adjusted.

17. The method of claim 16, wherein the amount of a negative aberration is generated or increased with the at least one first optical element and that the negative aberration generated or increased in terms of amount is changed with the at least one second optical element by changing at least one of the position and the optical properties of at least the first and second optical element such that the radiation in the processing zone has the second beam parameter product to be adjusted.

18. The method of claim 16, wherein the second beam parameter product is adjusted in dependence on a required processing result or at least one set or adjusting process parameter of a predetermined characteristic curve or a predetermined characteristic curve field.

19. The method of claim 16, wherein power density distributions of the focused radiation in planes perpendicular to the optical axis, which penetrate or intersect the processing zone when applying the focused radiation, with free propagation, and without a material in the beam path, are each defined by a first radius r1 defined of the second moment method and each having a second radius r2 at least 90 percent of the laser beam power being enclosed within a circle having the second radius r2, the second radius r2 being set at a maximum of 1.5 times the value of the first radius r1.

20. The method of claim 16, wherein power density distributions of the focused radiation, in planes perpendicular to the optical axis, which penetrate or intersect the processing zone when the focused radiation is applied, with free propagation, and without a material in the beam path, are each defined by a maximum power density which is less than 5 times the mean power density in the respective plane perpendicular to the beam axis on the surface enclosed by a circle of radius r1 defined by the second moment method.

21. The method of claim 16, wherein a control module of an adjusting device successively increases the second beam parameter product as a function of a required processing depth corresponding to a predetermined characteristic curve or a predetermined characteristic curve field from or above a predetermined processing limit depth as the required processing depth increases.

22. The method of claim 16, wherein the control module of the adjusting device adjusts a F-number, wherein the F-number defines an aperture size, of the focused radiation by means of at least one of a predetermined characteristic curve and a predetermined characteristic curve field in the event of a variation of the second beam parameter product, the F-number being a ratio of the distance of the beam waist to the last optical element at the exit of the beam-shaping optics and the beam diameter on this element.

23. The method of claim 22, wherein the F-number of the focused radiation is adjusted based on at least one of the predetermined characteristic curve and the predetermined characteristic curve field such that with a larger second beam parameter product the F-number at least one of remains constant and is increased.
